(19) United States
(12) Patent Application Publication
(10) Pub. No.: US 2013/0183557 A1
(43) Pub. Date: Jul. 18, 2013

(54) LEAD-ACID SAFETY BATTERY CAPPING DEVICE V-2

(71) Applicant: William R. Schwarz, Santa Fe Springs, CA (US)

(72) Inventor: William R. Schwarz, Santa Fe Springs, CA (US)

(21) Appl. No.: 13/374,847

(22) Filed: Jan. 13, 2012

(51) Int. Cl. H01M 2/12

(52) U.S. Cl. 429/87

(57) ABSTRACT

A battery capping device that rotates a plurality of breach locking battery caps by way of bars (rails) turning caps and/or sequence of caps for the simultaneous removal or installation of a multiplicity of battery caps. The present invention is designed for low profile in height and lateral space with ambidextrous access resulting from the bars (rails) being of truss bridge design with Lateral Digital Grip Protrusions as well as a Center Actuator Cap. The invention is specifically designed for inexpensive fabrication via the plastic injection molding process. The “LEAD-ACID SAFETY BATTERY CAPPING DEVICE V-2” incorporates the benefits of the “LEAD-ACID SAFETY BATTERY CAP” U.S. Pat. No. 6,746,795 B2, Schwarz.

### BACKGROUND OF THE INVENTION

1. Field of the Invention

The present invention relates to the “LEAD-ACID SAFETY BATTERY CAPPING DEVICE” quick release and insertion assembly that provides a simple and positive capping system using dual bars (rails) and Center Actuating Cap that rotate ganged battery caps incorporating benefits of the LEAD-ACID SAFETY BATTERY CAP, U.S. Pat. No. 6,746,795 B2, Schwarz Jun. 8, 2004 FIG. 7/FIG. 7a, a commercially successful battery cap used for insertion into fill/inspection ports of lead-acid storage batteries, particularly deep cycle, high charge and high discharge batteries used in golf carts, battery powered vehicles, floor scrubbers, forklifts and storage batteries in use to store electricity produced via alternative energy devices.

2. Description of the Prior Art

The prior art invention(s) simultaneously caps or removes caps from a plurality of fill/inspection ports, which define each individual cell of lead-acid storage battery. The service and inspection of a multiplicity of battery cell openings simultaneously has the obvious benefit of making a maintenance task less labor intensive. In the field of invention pertaining to golf carts reducing the task of maintenance has been necessitated due to the fact that the typical (6) six volt battery consist of (3) three cells requiring caps; whereby batteries are wired in series, parallel, or series parallel to achieve the desired voltage amperage combination, about six to eight batteries per golf cart, multiplied by the golf course's inventory of golf carts—about (20-60) twenty to sixty carts and considering this task to be preformed about (50) fifty times per battery life cycle. The present invention has been developed to accommodate a recent trend in golf carts to 12-volt batteries. FIG. 6 Unlike prior art the present invention has been designed to be more compact and allow a ganged capping device to fit on a battery and still allow room for battery hold downs.

When cells are in series circuit to increase voltage while in a common container, this unit is known in common parlance as a battery.

In the lead-acid type of battery, the cells employ negative plates using lead as the electroactive material and positive plates in which lead oxide is the electroactive material. The electrolyte in each cell is an aqueous sulfuric acid (H. sub.2 SO. Sub.4) solution. Each lead-acid cell produces (2) two volts of electromotive force per cell.

Each separate cell in a lead-acid battery requires a fill/inspection port. The purpose of this opening is to provide an opening for electrolyte filling, water replacement and inspection as well as specific gravity testing. The fill/inspection opening is also necessitated to provide a path to vent gas that is produced during charging and discharging of the battery cell.

The purpose of the battery cap is to contain the essential electrolyte in its respective battery cell as well as prevent spilling and spewing. The caustic sulfuric acid electrolyte will typically corrode metal fabrics and can cause personal injury upon contact. This has been problematic in prior art as a result of the simultaneous function of the battery cap is to vent potentially explosive mixture of oxygen and hydrogen liberated during the usual charging and discharging operation of the deep cycle battery, as well as preventing the spewing of electrolyte.

In the past prior art battery caps have been designed to attempt to solve these problems. In some cases the porous disc that provides a barrier to arrest/impede the entry of flames/sparks into the battery cell is protected from particle matter and electrolyte by splashguards. Examples of battery caps constructed in this way are described, for example, in U.S. Pat. Nos. 5,422,199; 5,209,992; 4,400,450 and 5,132,175. Also, some battery caps have been designed with labyrinth paths. Examples of these types of battery caps are found in U.S. Pat. Nos. 5,132,175; 5,209,992 and 5,422,199. In other battery caps special types of chambers have been constructed. Examples of these appear in U.S. Pat. Nos. 4,400,450; 5,132,175 and 5,422,199. Said prior art relates only to battery caps and not the present invention.

To mitigate the aforementioned problems intrinsic to large deep cycle batteries when high charging and discharging is occurring with the associated risk of battery explosion from external sources as well as spitting or spewing which typically erodes the battery compartment of the vehicle; past prior art made at least one of two compromises. (1) A baffle, labyrinth path or chamber, as above mentioned, is employed that allows free venting; however, this method alone, offers marginal explosion protection and marginal protection from spitting or spewing of battery electrolyte, or (2) the baffle, labyrinth path or chamber can also employ a porous disk spark/flame arrestor in the vent path for much added safety as well as less electrolyte being ejected from the battery cap; however, this porous disk loses porosity as the result of particle matter byproducts produced from eroding lead mixed in suspension with the electrolyte. Before precipitation to the bottom of the battery (mud) said particle matter while suspended in electrolyte will lodge in the porous disk until the loading of particles impedes the free flow of gas venting thus increasing the internal pressure of the battery whereby the size of the battery (envelope) will swell.

The problems and compromises associated with large deep cycle lead-acid batteries during high charge and discharge was accepted in past prior art until the LEAD-ACID SAFETY BATTERY CAP U.S. Pat. No. 6,746,795 B2 Schwarz, evolved. In this recent prior art a large microporous filter disk is protected from particle loading and contamination by a specifically designed diverter plate whereby spewed electrolyte is returned to the battery cell with remaining electrolyte by force of gravity and surface tension forming a temporary lenticular bubble seal. The functions and benefits of the LEAD-ACID SAFETY BATTERY CAP is described in detail in the above-referenced patent and its Original Equipment Manufacture (OEM) and aftermarket use is a commercial success.

The object of the present invention is to incorporate all the benefits of the LEAD-ACID SAFETY BATTERY CAP, U.S. Pat. No. 6,746,795 B2 Schwarz with the convenience of actuating a multiplicity of battery caps simultaneously via a unique system of bars (rails) with Center Actuating Cap turning caps.

3. Description of the Prior Art

The past prior art consist of two different devices for the sealing of a plurality of fill/inspection cell ports with one appliance. The following will describe (1) manifold devices and (2) devices that gang battery caps.

(1) Manifold devices function as one cap, e.g. “Battery closure means” or “Pod Vent” for sealing a plurality of battery cell fill/inspection ports;
(2) Individual battery caps ganged together functioning simultaneously to actuate a plurality of caps for the insertion or removal of the multiplicity of caps from fill/inspection ports in one mechanical motion.

(1) The manifold type device functioning as one cap sealing a plurality of battery cell fill/inspection openings is the standard device employed in the automotive field for the common (12) twelve volt battery. Some of these devices are commercially known as “Pod Vents”.

In the field of the deep cycle high charge and discharge batteries the usual single battery cap per battery cell is the most common; however, manifold devices such as the “Battery closure means” is a commercial success in the field of deep cycle high charge and discharge type batteries. The “Battery closure means”, U.S. Pat. No. 5,356,734, (1994) Nawaz, Trojan Battery Company, assignee, is commercially also known as the “Master Vent”. Other related inventions are: “Blow Molded Gang-Type Vent For A Multiple-Cell Electric Storage Battery” U.S. Pat. No. 3,943,008 (1976) Schaumburg; “multiple Vent Plug Assembly” U.S. Pat. No. 3,284,244 (1966) Llucas; “Device For Facilitating The Checking Of Storage Batteries” U.S. Pat. No. 2,570,123 (1951) Heine.

The above-mentioned “Battery closure means” is a manifold device using two porous disks spark/flame arrestors at the ends of the manifold labyrinth venting path connected to (3) three or otherwise a plurality of lead acid battery cells. This invention attaches the “Battery closure means” simultaneously to each cell opening by means of using an interference fit compressing the resilient sealing washers with downward force and tapered interference fit applying sealing force around the circumference and bayonet lugs of the fill/inspection ports of the battery cell. The “Battery closure means” will provide access to a plurality of battery cells fill/inspection openings by lifting/pulling generally and some wiggle along the “Y” axes while pulling up on the “X” axes. The “Battery closure means” is reattached to the fill/inspection openings by downward force.

The “Battery closure means” commercially known as “Master Vent” is currently used in Original Equipment Manufacture” (OEM) of batteries and like other aforementioned manifold devices it provides for sealing, venting and service of a plurality of battery cell openings. The “Battery closure means” like other manifold devices does not utilize the positive mechanism of rotation of the bayonet-style plug; it relies upon a snap type interference fit and thus is not related to the present invention.

(2) FIGS. 1 through 4 are the past prior art in relation with the current invention. The individual battery caps are ganged together functioning simultaneously to actuate a plurality of caps for the insertion or removal of a plurality of caps from multiple fill/inspection openings in one mechanical motion. These devices have a plurality of longitudinally spaced bayonet-style battery caps dimensionally centered to match the fill/inspection ports defining bosses of the intended battery cover.

The first commercial success with this system was the “Quick release storage battery closure assembly” U.S. Pat. No. 4,477,542 (1984) Braswell, commercially known as the “Speed Cap” FIGS. 1 and 2. This device ganged a plurality of bayonet-style battery caps by a common center rail locating the battery caps longitudinally to match the bosses on the battery cover that constituted each individual battery cell fill/inspection port. The cross-section of said rail is a box with one side missing in typical “U” formation (FIGS. 9 and 10) with holes cored via the plastic injection molding process to locate battery caps along said longitudinal axes. Each battery cap is fabricated to include a vertically disposed split pin that extends upward from the cap to be assembled via snap fit into holes fabricated along the rail.

The “Quick release storage battery closure assembly” (U.S. Pat. No. 4,477,542 Braswell) typical of the (6) six-volt battery, works by way of the center battery cap, or in other plurality of cap(s), will have two center caps, that incorporate a dual cam on the cylindrical body of the battery cap or caps. The caps outside of center will have a single cam with a vertically disposed split pin that is assembled into the cored hole of an outboard arm attached as mentioned to the outside of the center, cylindrical body dual cam of the center battery cap. This device employs two arms, essentially a reversible top and bottom parallel to the center rail connecting to the outside cam of the center cap.

The “Quick release storage battery closure assembly” requires at least (1) one dual cam type center cap(s); (2) two single cam type end caps (1) pair (two pieces) of arms and (1) one center rail. Also the usual porous disk, baffle and resilient washer per battery cap are required.

(2) FIGS. 3 and 4 show a further prior art in relation with battery caps ganged together functioning simultaneously to actuate a plurality of caps for the insertion or removal of said battery caps from the fill/inspection openings of storage batteries. This is the “Battery closure apparatus” U.S. Pat. No. 5,525,438, (1996) Kostrivas et al., assigned to Tulip Corporation and commercially known as “Spin Cap”®.

The aforementioned “Battery closure apparatus” AKA “Spin Cap”® functions via applying digital pressure in a clockwise or anticlockwise direction to the grip portions of the center cap or caps that simultaneously rotate the lateral outside caps kinetically by actuating assembled rails. Said rails assembles to the battery caps thru a plurality of holes cored out from the plastic injection process that cause a snap fit into the outside diameter of the caps with two split pins per cap at (180) one hundred and eighty degrees apart.

The “Battery closure apparatus” requires at least (1) pair (two pieces) of rails; (1) one battery cap with grip portion, and/or a pair, (2) two pieces for eight volt version; (2) two battery caps without grip portions and the usual porous disk, baffle and resilient washer per battery cap is required for assembly. See: FIGS. 3 and 4.

Instead of a cap rotating rails, i.e. Spin Cap® the present invention functions via bars (rails) 9 with Lateral Digital Grip Protrusions 23; Center Actuator Cap 14 turning caps and/or sequence of caps. FIG. 5 The assembly requires (2) types of caps for whatever plurality of caps and (1) type of bar (rail). The cap in this system will be the “LEAD-ACID SAFETY BATTERY CAP” U.S. Pat. No. 6,746,795 B2 Schwarz and the bars (rails) and actuator cap will be of unique and inexpensive design. The present invention is more particularly described under SUMMARY OF THE INVENTION.

### SUMMARY OF THE INVENTION

(1) An object of the present invention is to incorporate a positive breach lock providing positive pressure to each resilient washer sealing a plurality of battery caps at the fill/inspection ports. This same device will also provide for the removal and reinsertion of a plurality of caps with the speed of one mechanical motion of bars (rails) and Center Actuator Cap rotating a plurality of battery caps. Unlike prior art whereby a cap actuating rails, the present invention has a Center Actuator Cap and the actuating bars (rails) with Lateral Digital Grip Protrusions can be manipulated directly ambidextrously from an oblique angle as presented when a battery compartment is opened. Said Lateral Digital Grip Protrusions have eliminated most finger grip portions used in prior art and have enabled a ganged type quick release system to fit in the confines of a 12 volt golf cart battery with hold downs.

A further object of the present invention is a simpler bar (rail) injection molded to a flat ribbed truss bar with bosses cored from the injection molding process that provide the snap fit on the middle of the battery caps and outboard cams. The bars or rails are not the prior art “U” shape FIG. 9 detail 8 FIG. 10 The present invention incorporates ribbed trusses that add strength and rigidity to the bars (rails). Each bar (rail) has two Lateral Digital Grip Protrusions. 23

An object of the invention is the functioning of the Lateral Digital Grip Protrusions 23 that provide ambidextrous control of the bars (rails) rotating caps in either clockwise or anticlockwise positions to provide a positive breach lock seal or removal of the caps in one motion.

An object of the invention is the added leverage and convenience of the Center Actuator Cap that may be used in addition to the Lateral Digital Grip Protrusions. Unlike prior art, FIGS. 1 and 2, the “LEAD-ACID SAFETY BATTERY CAPPING DEVICE” is ambidextrous and incorporating the Lateral Digital Grip Protrusions 23 with Center Actuator Cap 14 provides easy access from oblique angles.

From lateral pressure on opposing Digital Grip Protrusions and/or Center Actuator Cap, all caps via cam action with outboard cams will lever positive pressure to each cap rotating a positive breach lock by revolving of said caps clockwise to activate internal breach locks pressuring the resilient washers into a tight seal. Rotation in the anti-clockwise direction will release all caps. The bars (rails) will not be the prior art design whereby a cap transfers force to rails, the current invention functions via bars (rails) and Center Actuator Cap turning outboard cams. The bars (rails) of the current invention are not prior art design cross-section resembling a “U” rail shape, 8 a simpler flat bar (rail) will lend itself to a simpler mold design for easier fabrication in the plastic injection molding process. See: FIGS. 8 through 11.

An object of the present invention is a means for easy, quick reinsertion of the battery caps by timing the positions of the breach locks to the open or reinsertion position via a positive stop. FIGS. 5, 8 and 11 13 Said stop (timing) leaves the individual battery caps rotated to the position matching the breach locks on the battery cover, FIG. 6 1, for easy reinsertion.

Yet another object of the present invention is the simplicity of assembly that can be accomplished without tools. The caps with flanged cams and the bars (rails) are the same. Left and right-handed bars (rails) and outboard-flanged caps have been eliminated.

Yet another object of the invention, is the elimination of the prior art “U” cross section shape of the bars (rails) FIGS. 9 and 10 8 The bars (rails) have been designed on the present invention to assemble into a lower profile configuration better suited for the confines of a battery compartment. The current invention FIG. 5 has been designed to be more compact that prior art FIGS. 1-4 eliminating unnecessary finger grips that use up lateral space. The present invention is the most compact and its design has been necessitated to accommodate space for battery hold-downs.

A major object of the present invention is to incorporate the benefits of the “LEAD-ACID SAFETY BATTERY CAP” U.S. Pat. No. 6,746,795 B2 Schwarz into caps ganged together that can actuated by the positive kinetic force leveraged digitally on the bars (rails) and Center Actuator Cap that provides for the insertion or removal of a plurality of caps in one mechanical motion.

The “LEAD-ACID SAFETY BATTERY CAP” allows gas to escape from the battery cell while simultaneously keeping electrolyte from spewing out of the battery cap and providing explosion protection. The electrolyte is returned to the battery cell and the micropourous disk is protected by a unique combination of a large opening at the bottom of the battery cap with a diverter plate returning spewed electrolyte. The mechanism by which the “LEAD-ACID SAFETY BATTERY CAP” works is more particularly described in the DESCRIPTION OF THE EMBODIMENT herein or U.S. Pat. No. 6,746,795 B2 Schwarz.

### DESCRIPTION OF THE DRAWINGS

FIG. 1 is the top view of prior art “Quick release storage battery closure assembly” commercially known as “Speed Cap”™ U.S. Pat. No. 4,477,542 (1984) Baswell.

FIG. 2 is the isometric view of FIG. 1 prior art “Quick release storage closure assembly” AKA “Speed Cap”.

FIG. 3 is the top view of prior art “Battery closure apparatus” U.S. Pat. No. 5,525,438 (1996) Kostrivas et al., assigned to Tulip Corporation and commercially known as “Spin Cap”®.

FIG. 4 is the isometric view of FIG. 3 prior art “Battery closure apparatus” AKA “Spin Cap”®. U.S. Pat. No. 5,525,438 (1996) Kostrivas et al., assigned to Tulip Corporation.

FIG. 5 is the isometric view of the present invention “LEAD-ACID SAFETY BATTERY CAPPING DEVICE” AKA V-2

FIG. 6 is a top view of the present invention “LEAD-ACID SAFETY BATTERY CAPPING DEVICE” AKA V-2 installed on a typical 12-volt golf cart battery. Note: Most prior art golf cart batteries are of 6-volt design.

FIG. 7 is top, side, isometric, and section(s) views of prior art “LEAD-ACID SAFETY BATTERY CAP” U.S. Pat. No. 6,746,795 B2 Schwarz. Said prior art has been redesigned for the current invention the “LEAD-ACID SAFETY BATTERY CAPPING DEVICE” showing the middle cape known as the Center Actuator Cap.

FIG. 7a is top, side, isometric, and section(s) views of prior art “LEAD-ACID SAFETY BATTERY CAP” U.S. Pat. No. 6,746,795 B2 Schwarz. Said prior art has been redesigned for the current invention the “LEAD-ACID SAFETY BATTERY CAPPING DEVICE” showing the (2 req.) outside caps without the lever incorporated into the Center Actuator Cap.

FIG. 8 is a bottom view and section view of the bar (rail) in the present invention.

FIG. 9 is a bottom view and section view of the bar (rail) prior art “Battery closure apparatus” AKA “Spin Cap”®

FIG. 10 is a bottom isometric view of FIG. 9.

FIG. 11 is a bottom isometric view of the present invention bar (rail).

### DESCRIPTION OF DETAILS

### Detail#

1 battery, battery cover
2 positive battery post
3 negative battery post
4 means of attaching a handle
5 outboard caps
6 hole (as used to locate cap on bar/rail)
7 cross section of bar (rail) on present invention
8 “U”-cross section of prior art
9 bar (rail)
10 ribs
11 Center Actuator Cap Lever
12 split pin(s)
13 bar (rail) stop(s)
14 Center Actuator Cap
15 bayonet lug(s)
15a lead chamfer
16 flange/cam
17 bulbous
18 non-interference body (bearing surface)
19 downwardly convex projection
20 bottom opening
21 diverter plate
22 micropourous disk
23 Lateral Digital Grip Protrusion(s)

### DESCRIPTION OF THE EMBODIMENT

FIG. 6 illustrates a top view 1 of a (12) twelve-volt heavy duty, deep cycle lead-acid storage battery that is currently being introduced for use in golf carts. This top view (FIG. 6) also shows the positive battery terminal post 2 and the negative post 3 as well as the top view of a molded flange to facilitate the battery fabrication process and a means of attaching a handle 4. The deep cycle, high charge and high discharge type lead-acid storage batteries are typical in golf carts, battery powered vehicles, floor scrubbers, forklifts and batteries used to store electricity produced via alternative energy devices.

The battery illustrated in FIG. 6 has (6) six cells that are covered by the caps 5, 14 employed by the present invention, the “LEAD-ACID SAFETY BATTERY CAPPING DEVICE”. Each cell in the lead-acid type storage battery typically consists of lead plates as the negative electroactive material and lead oxide as the positive electroactive material. The electrolyte in each cell is an aqueous sulfuric acid solution. Each lead-acid cell produces (2) two volts of electromotive force. When cells are connected in series the voltage of each cell is added; thus FIG. 6 illustrates (6) six cells covered by the caps 5, 14 of the present invention, and the sum of each (2) two-volt cell is a (12) twelve-volt battery.

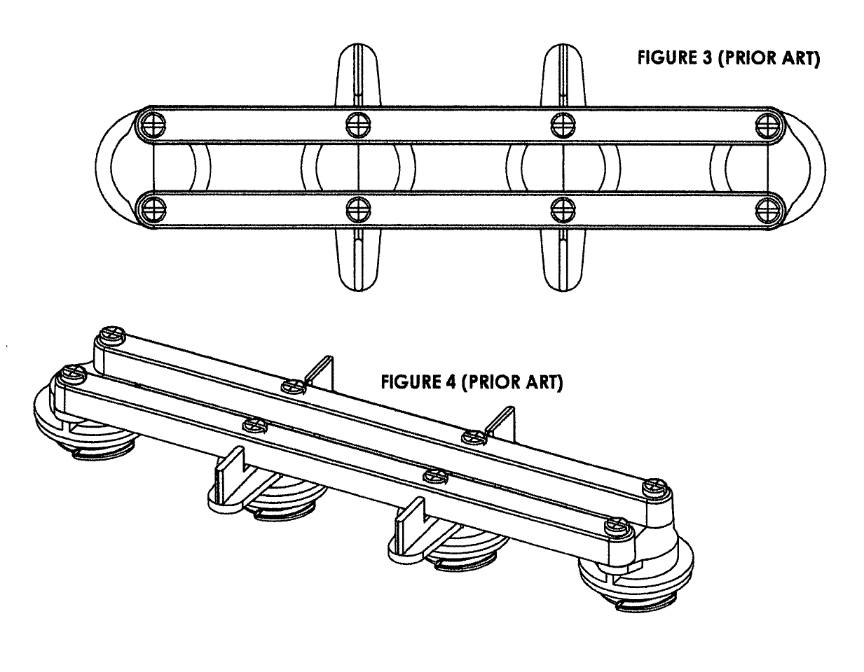

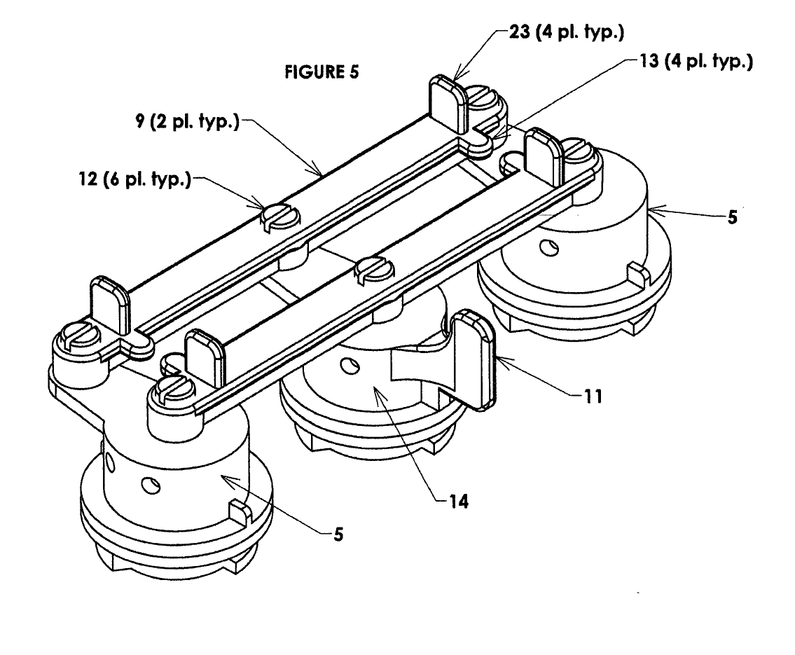

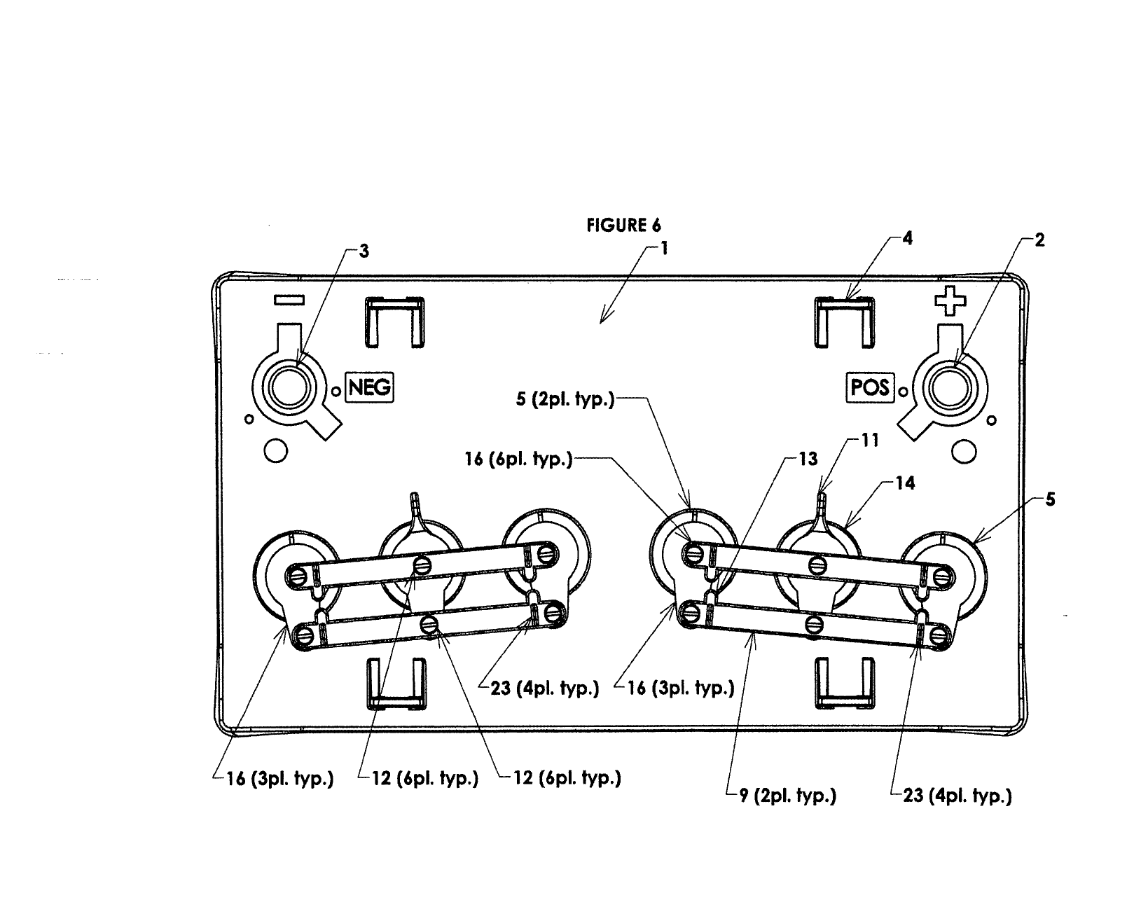

The (6) six-volt battery dominates the golf cart industry at the present time; however, the (8) eight-volt has been introduced. Prior art has been developed to accommodate the (8) eight-volt battery by simultaneously rotating a plurality of (4) four battery caps, for example SEE: FIGS. 3 and 4, “Battery closure apparatus”. The commercial success of the (8) eight-volt battery and its related market share is yet to be determined. The current invention “LEAD-ACID SAFETY BATTERY CAPPING DEVICE” has been developed to accommodate the (12) twelve-volt golf battery (two sets of present invention required) FIG. 6 However, via alterations in mold making the present invention can be adapted into any usual plurality of battery caps.

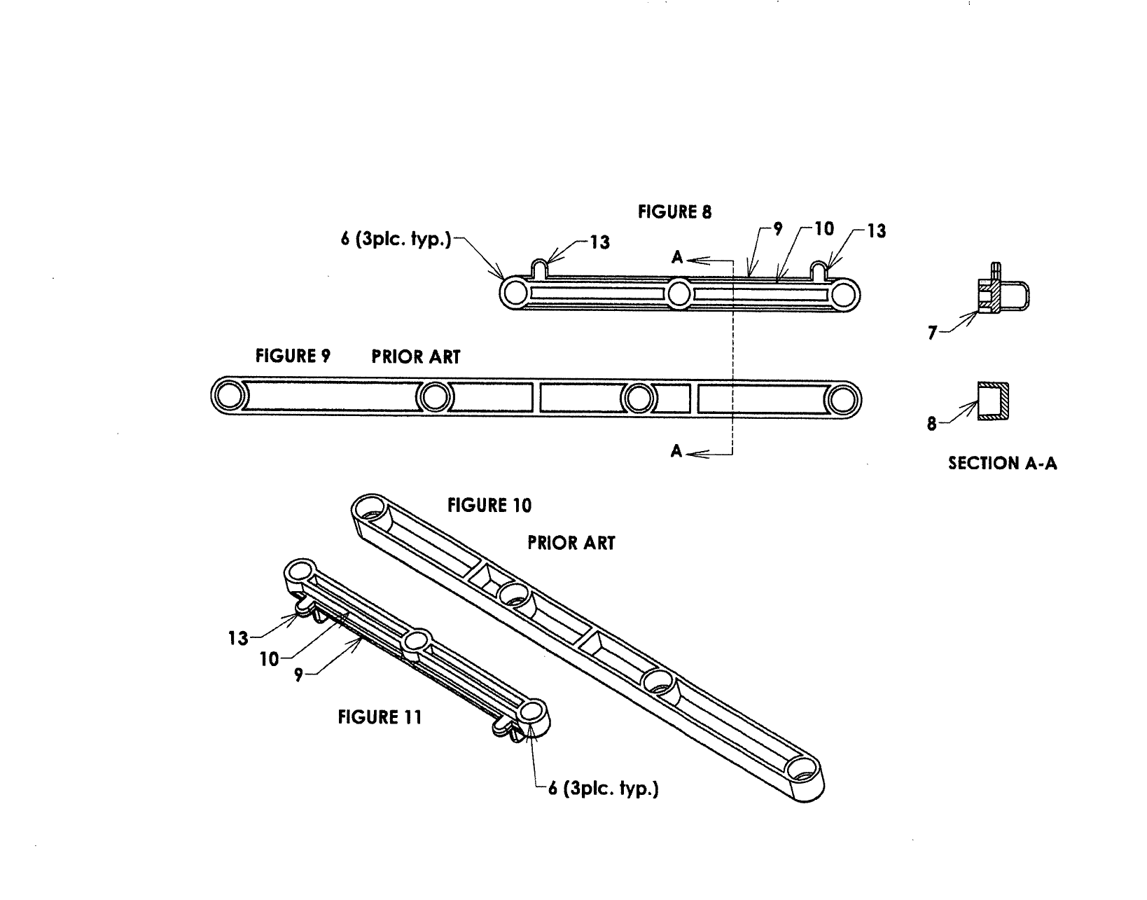

An object of the present invention is the ease of adapting the “LEAD-ACID SAFETY BATTERY CAPPING DEVICE” from (6) volt to (8) volt batteries or other pluralities of caps to seal lead-acid battery cells. This is accomplished by altering the bar (rail) FIG. 8, 9. In the matter of plastic injection molding, the bar cavity of the mold need only be milled longer with corresponding core pin added to produce a hole 6. The simplicity of mold design is illustrated in FIGS. 8 and 11 on section view “A-A (top illustration)” 7 when compared with prior art design of the “U” shape 8.

The ease of mold making of the bar (rail) FIGS. 8 and 11 is another object of the invention. A simple flat cut with an endmill forms the body of the bar (rail) 9 with a supporting ribs 10 cut parallel to the bar (rail). A core pin that makes holes 6 for press fit into the split pins, FIG. 5 12.

Yet another object of the invention is that the unique bar (rail) FIG. 8 9 incorporates a plurality of holes FIGS. 8 and 11 6, core pined from the plastic injection molding process. Said holes are of the interference fit diameters that assemble into the split pins FIG. 5 12

The “LEAD-ACID SAFETY BATTERY CAPPING DEVICE” aka V-2 only requires one type of bar (rail) and two types of caps to build a complete assembly. FIG. 5 This makes assembly on a mass production basis faster and saves on inventory problems.

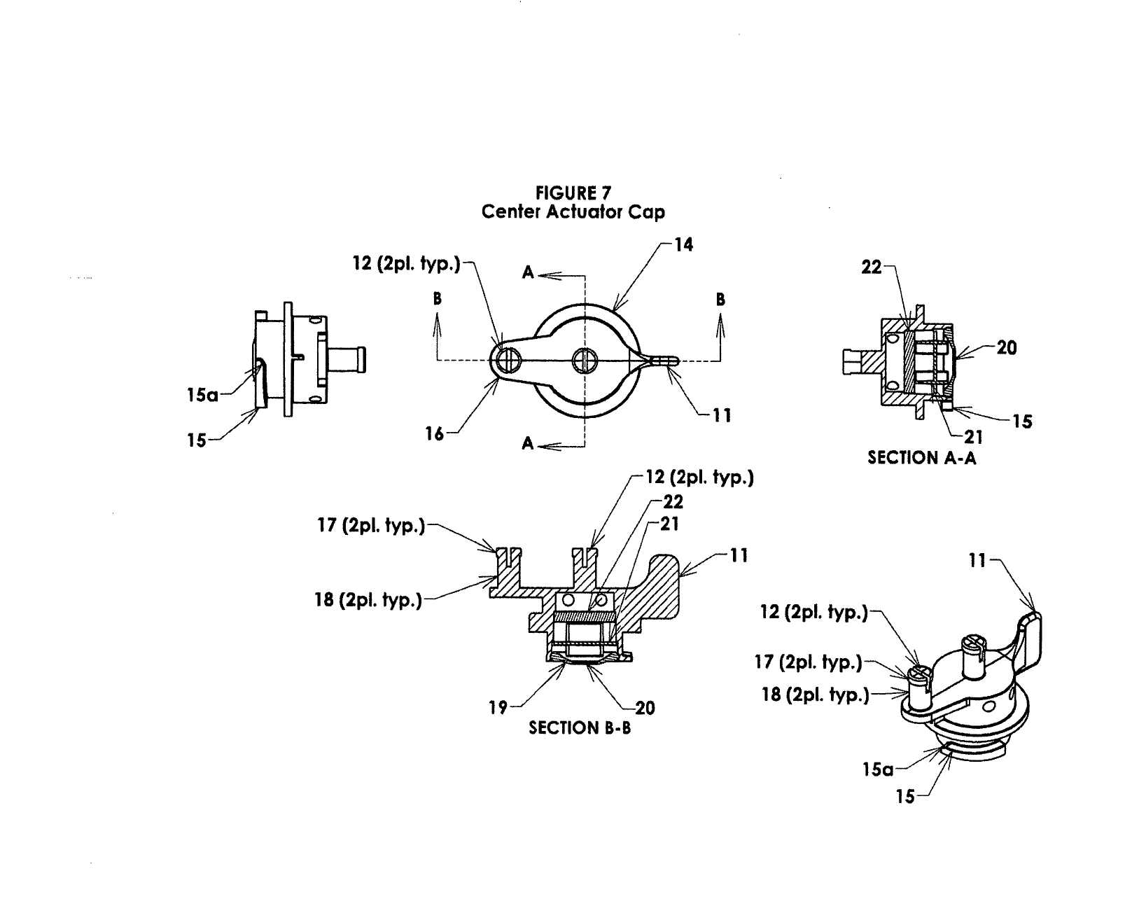

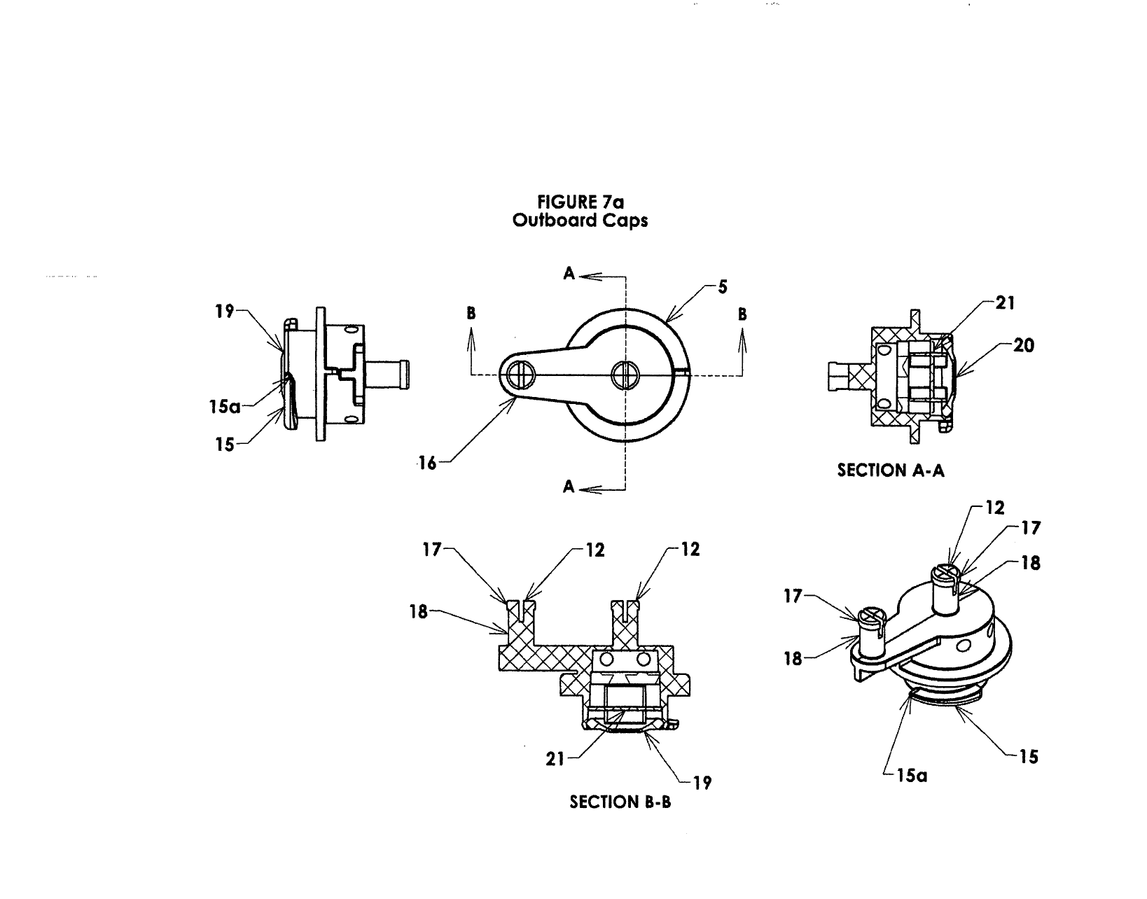

FIG. 5 illustrates the “LEAD-ACID SAFETY BATTERY CAPPING DEVICE” aka V-2 fully assembled and FIG. 6 shows the present invention installed on a (12) twelve-volt battery with caps 5; 14 rotated in the clockwise direction thus applying positive pressure via bayonet lugs FIG. 7 15 to the resilient washers (Not shown). The bayonet lugs FIG. 7 15 are molded to produce an incline that will progressively increase pressure on the resilient washer as the cap is rotated clockwise.

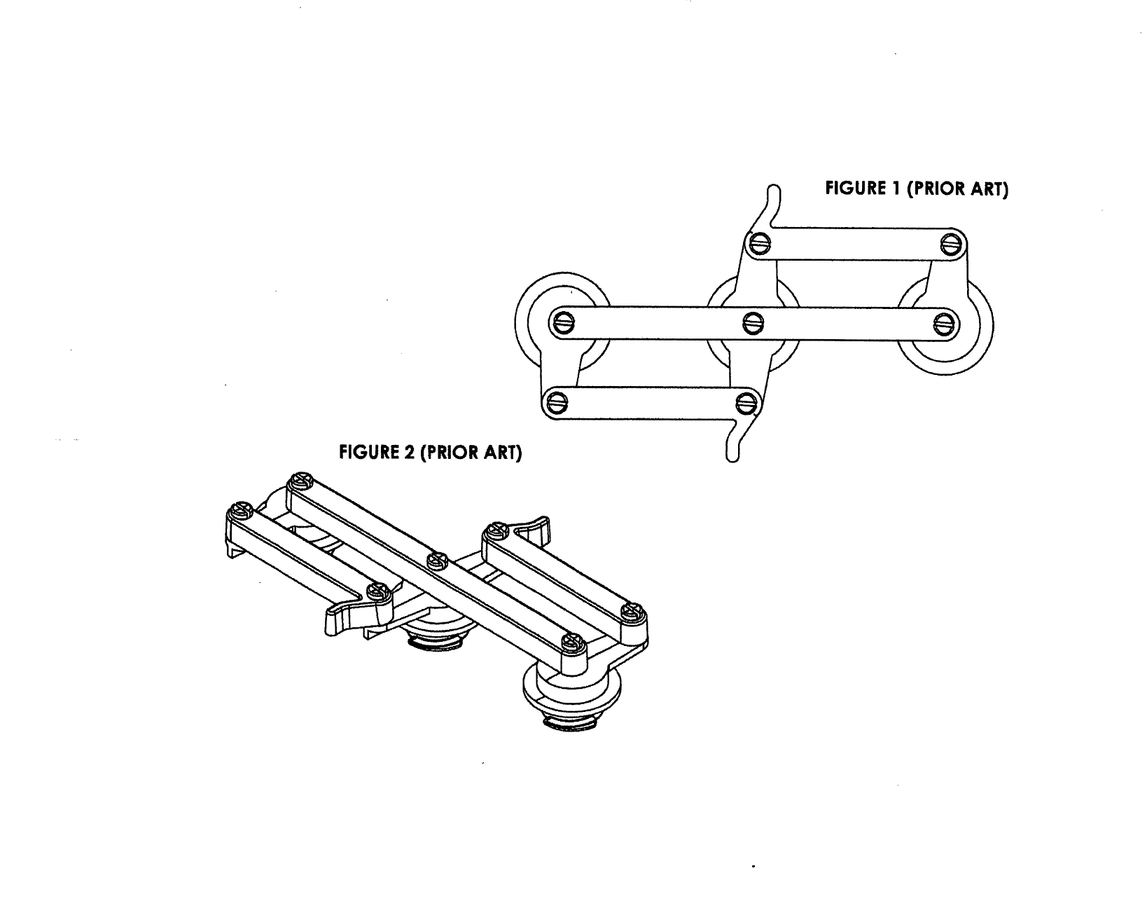

At the lead of the incline, which progressively increases pressure on the resilient washer, FIG. 7 15 is the lead chamfer FIG. 7 15a. Prior art has neglected this simple lead chamfer that is a simple 45 degree angle. Plastic battery covers and related “LEAD-ACID SAFETY BATTERY CAPPING DEVICE” like all plastic parts are not precision machined parts and subject to some distortion. This lead chamfer FIG. 7 15a makes insertion and removal of the “LEAD-ACID SAFETY BATTERY CAPPING DEVICE” simpler and faster that prior art. FIGS. 1, 2, 3, 4.

FIG. 6 also illustrates a top view of the caps 5, 14 as it covers each fill/inspection opening of each battery cell; as illustrated a plurality of (3) three cells.

On the outboard of each cap is a flange/cam FIG. 7 16; FIG. 7a 16 FIG. 6 16 and a vertically protruding split pin FIG. 6 12; FIG. 7 12 FIG. 7a 12. The split pin does incorporate two splits, 180 degrees apart paralleling the vertical protrusion of said split pin. See: FIG. 7 12 Said split pin is in the center of all caps and the cam portion of all caps.

At the upper end of the split pin is a bulbous increase of diameter, FIG. 7 17 to produce an interference fit for permanent assembly with the bar (rail) FIG. 11 9, FIG. 5 12. After assembly, the purpose of the bulbous part of the split pin is to permanently hold the assembly together, FIG. 5 12, while simultaneously allowing the bar (rail) FIGS. 8 and 11 to freely pivot the non-interference body of the split pin FIG. 7 18; FIG. 7a 18.

Another unique object of the present invention is bars (rails) and Center Actuator Cap turning outboard cams as opposed to caps actuating bars (rails). See: prior art FIGS. 3 and 4

FIG. 6 shows a top view of the present invention as applied to a (12) twelve-volt deep cycle battery that is being introduced for golf carts and alternative power vehicles. As shown in FIG. 6 the caps 5, 14 are rotated fully to the clockwise position sealing the fill/inspection openings. On the outboard of each cap 5, 14 is a flange/cam 16 that provides positive leverage from the manual movement of the Lateral Digital Grip Protrusions FIGS. 5, 6, 8, 11 23 and Center Actuator Cap. FIG. 7 14; 11

In the present invention each cap is molded with an outboard flange/cam FIGS. 7 16 and 7a 16(also FIG. 6 16) that act as positive levers. Force is directly applied to each flange/cams to the non-interference body of the split pin, FIG. 7 18, via direct contact with the bars (rails) via Lateral Digital Grip Protrusions FIG. 5 3 and/or Center Actuator Cap FIG. 6 14; said force from the bars (rails) is transferred evenly through the bars (rails) 9 from applied digital pressure.

A major object of the present invention is the incorporation of the improved “LEAD-ACID SAFETY BATTERY CAP” U.S. Pat. No. 6,746,795 B2 Schwarz. The slower prior art design of using radially projecting wings to facilitate the gripping for twisting and untwisting method for removal and insertion of caps will be updated to the present invention employing “LEAD ACID SAFETY BATTERY CAPPING DEVICE”. The internal mechanism in each cap will be essentially the same as the “LEAD-ACID SAFETY BATTERY CAP” U.S. Pat. No. 6,746,795 B2 Schwarz.

The fluid dynamics, design, and function of the prior art “LEAD-ACID SAFETY BATTERY CAP” is in detail under the aforementioned patent. The short explanation of this device can be described (FIGS. 7 and 7a) from the bottom of the cap being of solid molded construction producing a downwardly convex projection 19. When the bayonet lugs 15 tighten against the fill/inspection openings of the battery cell and apply pressure to the resilient washers (Not illustrated), the gas, spitting, spewing as well as “mud” from the battery cell is directed into the bottom opening 20 of the battery cap. The spitting, spewing electrolyte with the particle matter (mud) is forcibly ejected back through opening 20 and directed back into the battery cell by the diverter plate. 21 The diverter plate 21 is formed generally in the shape of a table supported by legs (this captures electrolyte). The diverter plate 21 is of semicircle design with two notches 180 degrees apart with diametrically opposed notches on the top of the table design. This provides a positive vent way for gas escape. The diverter plate 21 is the first successful design that returns battery electrolyte and particle matter into the battery cell thus successfully protecting the micropours disk 22 from being occluded by particle matter. The last remaining electrolyte not returned to the battery cell proceeds downward from the legs to be trapped via surface tension in the opening 20 to form a lenticular bubble. The lenticular bubble forms a positive seal that is broken by vibration or fluctuations in gas pressure and the process is again repeated.

The unique function of the diverter plate 21 is to provide extra protection to the microporous flame arrester disk 22 from losing porosity from “loading” of particle matter of suspended lead (mud) in the electrolyte. The object of the oversized (⅛ by 1 inch diameter) microporous disk 22 is to increase efficiency, service life, and work in combination with the other elements i.e. diverter plate 21 and the opening 20 to form and maintain the lenticular bubble.

Obviously, numerous variations and modifications of the present invention will become readily apparent to those skilled in the art of battery cap construction for lead-acid electrical storage batteries. Accordingly, the scope of the invention should not be so construed to be inclusive and limited to the specific embodiments depicted and described.

What is claimed is:

1. The “LEAD-ACID SAFETY BATTERY CAPPING DEVICE” AKA “V-2” is a device for the insertion and removal of a plurality of “LEAD-ACID SAFETY BATTERY CAP”(S) from the fill/inspection openings of lead-acid storage batteries in one rapid mechanical motion.

2. A quick release and closure battery capping device that exclusively incorporates the benefits of the LEAD-ACID SAFETY BATTERY CAP, U.S. Pat. No. 6,746,795 B2, Schwarz.

3. A quick release and closure battery capping device according to claim 1 and claim 2 that when assembled will only consist of two types of caps and one type of bar (rail).

4. A quick release and closure battery capping device incorporating the simplicity of design of a flat bar (rail) typically to adapt to three cells, or other plurality of cells, typically used in lead-acid storage batteries. Said bar (rail) may be extended to adapt to the (8) eight volt, four cells, or other plurality of cells by simple fabrication of longer bars (rails).

5. The simplicity of the flat bar (rail) design used in combination with a variety of batteries having a plurality of spaced upward cylindrical bosses that define each cell of the fill/inspection openings can be simply altered to fit different dimensional requirements of different batteries via simple tooling adjustments by changing the location of the holes on the flat bar (rail).

6. A flat bar (rail) design with two longitudinal parallel ribs trusses that add strength and rigidity to the bars (rails).

7. Positive stops positioned on the bars (rails) that stop rotatation (timing) of each breach lock to the open or reinsertion position.

8. A quick release and closure battery capping device according to claim 1 and 2 applying positive pressure of bars (rails) rotating a plurality of battery caps.

9. A modified version of the LEAD-ACID SAFETY BATTERY CAP, U.S. Pat. No. 6,746,795 B2, Schwarz according to claim 5 with outboard Lateral Digital Grip Protrusions that provide positive force/leverage by digitally applying force directly to the Lateral Digital Grip Protrusions that project perpendicular outwardly from the bars (rails) operating the system of bars (rails) rotating caps.

10. A modified version of the LEAD-ACID SAFETY BATTERY CAP, U.S. Pat. No. 6,746,795 B2 Schwarz according to claim 5 with outboard flange/cams that provide positive force/leverage by digitally applied force in any combination of the Lateral Digital Grip Protrusions and the Center Actuator Cap turning caps.

11. A Lead Chamfer at the beginning of the incline of the breach lock portion at the bottom of the battery cap.

12. A “LEAD-ACID SAFETY BATTERY CAPPING DEVICE” according to claims 3 and 5 eliminating prior art “U” cross-section shape of bars (rails) to the more compact truss design.

13. The elimination of unnecessary finger grips employed in prior art design of caps that use up lateral space and thus the current invention of more compact design allows space for battery hold-down while simultaneously providing space for mechanically capping multiple caps with one mechanical motion.
